(19) United States
(12) Patent Application Publication
(10) Pub. No.: US 2008/0076512 A1
(43) Pub. Date: Mar. 27, 2008

(54) GAMING SYSTEM COMPRISING SPECIFIC PRIVILEGED AREA FOR INVITED PLAYERS

(75) Inventor: Eiji AIDA, Zama city (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING INCORPORATED, Las Vegas, NV (US)

(21) Appl. No.: 11/534,220

(22) Filed: Sep. 22, 2006

(51) Int. Cl. A63F 13/00

(52) U.S. Cl. 463/20; 463/42

(57) ABSTRACT

A gaming system of the present invention is arranged in a location like a hotel and casino, wherein a server connects virtual gaming machines with mobile gaming terminals that customers can carry in any of the areas in the location. The server selects one mobile gaming terminal in a lottery process, and stores customer ID data for the player in possession of the selected mobile gaming terminal. The server detects the mobile gaming terminals that are located in a specific area, and checks the customer ID data received from the detected mobile gaming terminals. If the received customer ID data is the same as the customer ID data stored in the server, the server will allow the player who input the detected customer ID data to play a special game on the mobile gaming terminal located in the specific area, or on a gaming machine installed in the specific area.

### BACKGROUND OF THE INVENTION

1. Field of the Invention

The present invention relates to a gaming system, and in particular, a server-based gaming system that comprises a plurality of mobile gaming terminals.

2. Background Information

In general, large casinos such as the ones in Las Vegas are established as an annex to a hotel, together with various amenities such as restaurants, shopping centers, theaters, and concert halls, into one huge place (hereinafter, an entertainment center). Customers staying at the hotel can play various types of games, eat various types of food, shop at various types of stores, and enjoying various types of entertainment, within the entertainment center. Such additional amenities attract customers, and accordingly increase the number of players in the casino.

A server-based gaming system has been recently proposed for use in such an entertainment center in order to improve the profitability of gaming services. The gaming system comprises a plurality of mobile gaming terminals, each of which can wireless communicate with a server anywhere in the entertainment center. For example, each customer is provided with one of the mobile gaming terminals at the front desk of the hotel, in return for registering one's personal information with the server. The customer can then play a game (e.g., an online slot or poker game) on the mobile gaming terminal in any gaming-allowed area of the entertainment center, for example, while waiting for food one has ordered at a restaurant, or while waiting for one's partner while he or she is shopping. In addition, by using the mobile gaming terminals, the server can provide customers with various kinds of useful information about each area of the entertainment center (e.g., a map, details on services provided by restaurants and shops, a list of shows at the theaters in the entertainment center, and guidance on gaming machines in the casino). The server also causes the mobile gaming terminal to function as a navigation system, thereby enabling the customers to navigate the various areas of the entertainment center.

In the above-mentioned entertainment center, many customers will avoid the casino, and only go to the areas of the entertainment center other than the casino. Accordingly, a new idea is desired in order to interest such customers in the casino, and thereby increase the number of players in the casino. It can be expected that the above-mentioned server-based gaming system will improve the profitability of gaming services, but it is doubtful whether the gaming system will also improve profitability of the casino itself. The gaming system allows customers to play games in any location, and thus may cause some customers to play games at the casino, but may also reduce the motivation of other customers to go to the casino.

In view of the above, it will be apparent to those skilled in the art from this disclosure that there exists a need for an improved gaming system which can invite players to come to a specific area in a location (e.g., the casino area in an entertainment center). This invention addresses this need in the art as well as other needs, which will become apparent to those skilled in the art from this disclosure.

### SUMMARY OF THE INVENTION

A gaming system according to the present invention is arranged in a location, preferably the above-mentioned entertainment center, and comprises a plurality of mobile gaming terminals and a server that are interconnected therebetween to wireless communicate with each other. The mobile gaming terminals are each configured to send customer ID data from a player to the server, display game content in accordance with data received from the server, and send data entered by a player into the mobile gaming terminal to the server. The server comprises a plurality of virtual gaming machines, a special-game lottery unit, a terminal tracking unit, and a special-game controller. The virtual gaming machines are each configured to run a game program, send game content to one of the mobile gaming terminals that is linked to the virtual gaming machine, and receive the player's responses from the mobile gaming terminal. Thus, the mobile gaming terminals and the server constitute a server-based gaming system. The special-game lottery unit is configured to select one of the mobile gaming terminals in a lottery process, which is preferably independent of the gaming processes of each virtual gaming machine. The special-game lottery unit is further configured to store customer ID data that the server has received from the selected mobile gaming terminal, and inform the selected mobile gaming terminal that the player in possession thereof is provided with an opportunity to play a special game in a specific area of the location, preferably the casino or a section thereof in the above-mentioned entertainment center. Here, the special game is a game that a typical player will want to play, preferably a game with a higher payback percentage or a larger jackpot value. The terminal tracking unit is configured to detect the mobile gaming terminals that have been brought into the specific area. The special-game controller is configured to check customer ID data that the server has received from the mobile gaming terminals detected by the terminal tracking unit in the specific area, and when the same customer ID data as the customer ID data stored in the special-game lottery unit has been detected, the player who has entered the detected customer ID data will be allowed to play a special game on the mobile gaming terminal detected in the specific area.

The above-mentioned gaming system according to the present invention selects one of the mobile gaming terminals at random, and allows a customer who uses the selected mobile gaming terminal to play the special game only when the customer brings his or her mobile gaming terminal into the specific area. Accordingly, it can be expected that the customer will go to and stay in the specific area, and therefore the number of players will increase in the specific area. When the specific area has been assigned to the casino or a section thereof, it can be expected that the number of players playing games on gaming machines fixed in the casino will increase, and therefore the profitability of the casino will improve.

In the above-mentioned gaming system according to the present invention, the terminal tracking unit is preferably configured to detect the area of the location in which each of the mobile gaming terminals is located, and the special-game lottery unit preferably varies the lottery probabilities for each of the mobile gaming terminals based upon the detected location of each of the mobile gaming terminals. Variation in the lottery probabilities can control the number of players to go to or stay in the specific area. When the lottery probability is lower in the specific area compared to other areas, the number of the players who only stay in the areas other than the specific area may decrease. When the lottery probability is higher in the specific area compared to other areas, the number of players who will go to and stay in the specific area may increase.

Preferably, the server further comprises a customer management unit that comprises a player tracking controller and a customer database. The player tracking controller is configured to authenticate a player of the mobile gaming terminal, based on customer ID data received from the mobile gaming terminal. The customer database is configured to store customer information linked to customer ID data. In addition to that, the special-game lottery unit preferably varies the lottery probabilities based upon the customer information linked to customer ID data received from each of the mobile gaming terminals. Variation in lottery probabilities can control the type of players in the specific area. For example, when the lottery probability is higher for players with a higher number of credits stored in the server, the number of such players may increase in the specific area.

Preferably, the terminal tracking unit is configured to detect the area of the location into which each of the mobile gaming terminals is brought, and the server further comprises a guiding unit that is configured to provide the mobile gaming terminal selected by the special-game lottery unit with a map indicating the specific area.

The above-mentioned gaming system may comprise a plurality of gaming machines that are installed in the location and connected to the server, each gaming machine configured to send customer ID data from a player to the server, and to allow the player to play a game on the gaming machine in accordance with an instruction from the server. In this case, the special-game controller may be configured to check customer ID data that the server has received from the gaming machines installed in the specific area of the location, and when the same customer ID data as the customer ID data stored in the special-game lottery unit is detected, the player who has entered the detected customer ID data will be allowed to play a special game on the gaming machine installed in the specific area. In other words, the special game may be provided on either on the mobile gaming terminal that is brought into the specific area, or on the gaming machine fixed in the specific area.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a network diagram of a gaming system according to one embodiment of the present invention;

FIG. 2 is a perspective view of the appearance of a gaming machine shown in FIG. 1;

FIG. 3 is a block diagram of the configuration of the gaming machine shown in FIG. 2;

FIG. 4 is a plan view of a mobile gaming terminal shown in FIG. 1;

FIG. 5 is a block diagram of the configuration of the mobile gaming terminal shown in FIG. 4;

FIG. 6 is a block diagram of the configuration of a server complex shown in FIG. 1;

FIG. 7 is a flow chart of a process for starting a game on the mobile gaming terminal shown in FIG. 1;

FIG. 8 is a flow chart showing a special-game lottery process in the gaming system shown in FIG. 1;

FIG. 9 shows window images displayed on the mobile gaming terminal selected by the special-game lottery process; and

FIG. 10 is a flow chart that shows a process for starting game on a gaming machine shown in FIG. 1 when a player is selected by the special-game lottery process.

### BEST MODE FOR CARRYING OUT THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

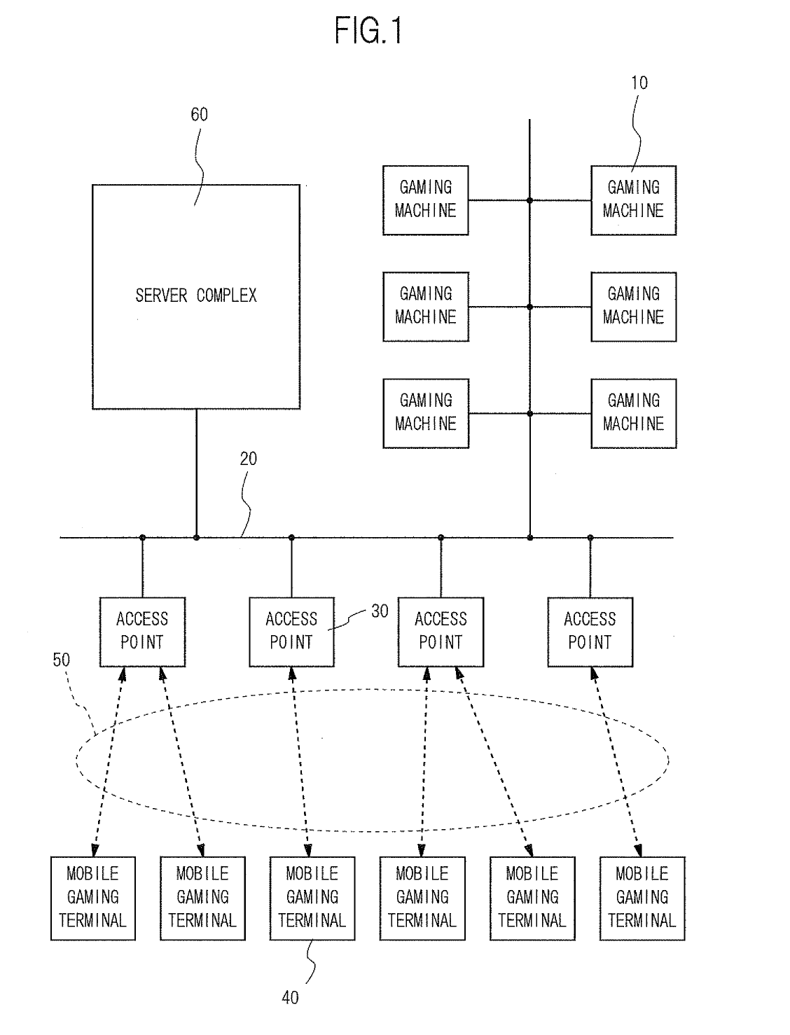

A gaming system according to one embodiment of the present invention is preferably installed in an entertainment center, in which a large casino is established as an annex to a hotel, together with various amenities such as restaurants, shopping centers, theaters, concert halls, pools, gyms, and the like. The entertainment center is divided into a plurality of areas, which are assigned to one or more sections in the casino, the restaurants, the shops, and other facilities included in the entertainment center. As shown in FIG. 1, a plurality of gaming machines 10 are installed in areas included in the casino, and connected to a server complex 60 through a LAN 20 (preferably, IEEE 802.3) running throughout the entertainment center. At least one access point 30 is set and connected to the LAN 20 in each of the areas, and thereby, from any area in the entertainment center, a mobile gaming terminal 40 can be wirelessly connected to any of the access points 30 through a wireless LAN 50 (preferably, IEEE 802.11×).

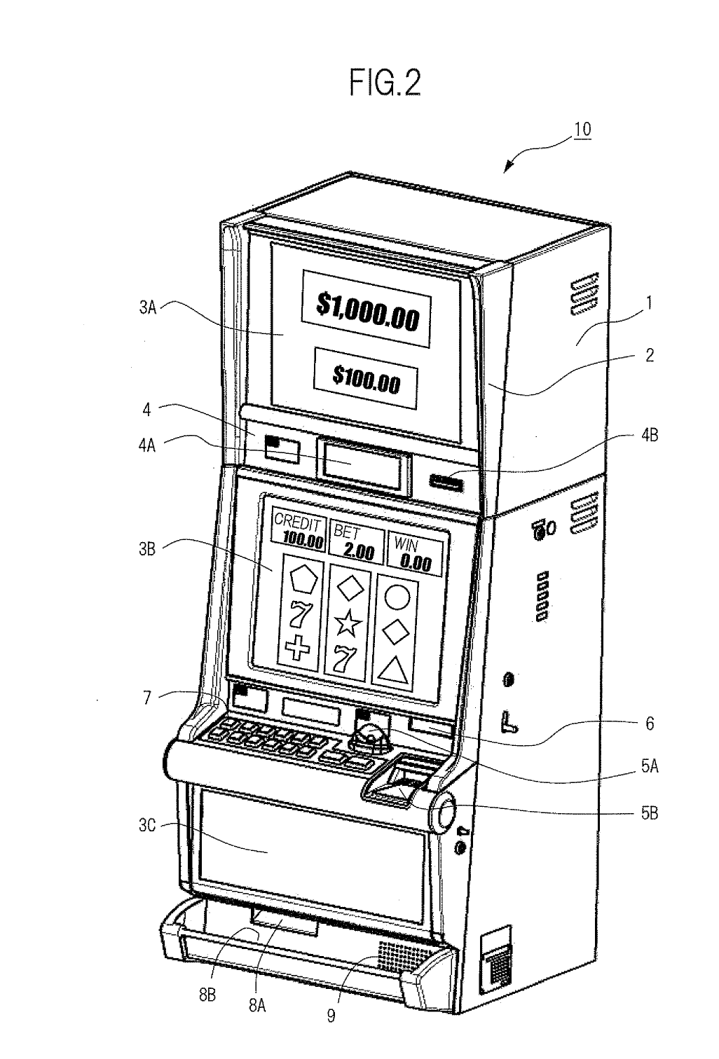

Each of the gaming machines 10 is preferably a video slot machine 10 shown in FIG. 2, which comprises a box-shape cabinet 1 with a front panel 2. Three display windows 3A, 3B, and 3C are provided on the upper portion, the middle portion, and the lower portion of the front panel 2, respectively. A player tracking unit 4 is installed between the upper display window 3A and the middle display window 3B. The player tracking unit 4 includes a touch screen 4A and a card slot 4B. On the front panel 2, a coin inlet 5A, a bill/ticket inlet 5B, a ticket outlet 6, and buttons 7 with various functions are provided between the middle display window 3B and the lower display window 3C, and a coin outlet 8A, a coin receiver 8B, and a speaker 9 for providing sound effects are installed below the lower display window 3C.

The three display windows 3A, 3B, and 3C reproduce various images, for example, images for use in decoration such as the logo of a game developer, images for use in advertisements, images for use in visual effects in games, and visualized information about games such as pay tables, illustration of game content, and jackpot values. In particular, the upper display window 3A displays two (or more) levels of jackpot, and the middle display window 3B displays three (or more) symbol columns, the number of available credits of a player, the amount of a bet, and the amount of an award that the player has won.

The player tracking unit 4 is linked to the server complex 60 through the LAN 20 (cf. FIG. 1). A player who will start playing games on the gaming machine 10 will first insert his/her ID card into the card slot 4B. The ID card has been prepared and provided to each customer in advance, generally when the customer has been registered with the server complex 60 at the reception desk in the casino, the front desk in the hotel, or the like in the entertainment center. The ID card stores identification data (customer ID data) of the customer. A card reader installed in the card slot 4B reads the customer ID data from the ID card inserted in the card slot 4B, and then the player tracking unit 4 sends the customer ID data to the server complex 60. The server complex 60 then authenticates the player based on the received customer ID data. In addition, the server complex 60 may require the player to enter additional personal information (preferably a password) through the touch screen 4A, and, if the additional personal information matches the registered personal data, the server complex 60 may allow the player to use his/her credits, which have been stored in the server complex 60 in advance, for playing games on the gaming machine 10. The ID card also stores the number of points provided to the player based upon the amount of money that the player has spent in the entertainment center. For example, the player can receive a bonus such as a free accommodation coupon for the hotel and a gift certificate for use in the restaurants and shops, based on the number of the points. If the authentication is successful, the touch screen 4A will display the number of points. When the player finishes playing games on the gaming machine 10, the player tracking unit 4 will preferably update the points stored in the ID card based upon the money that the player has spent on the gaming machine 10, and inform the server complex 60 of the updated points.

Coins and bills that the player enters into the coin inlet 5A and the bill/ticket inlet 5B, respectively, are counted by a coin counter installed inside the cabinet 1, and then, the total amount of the coins and bills are displayed on the middle display window 3B as credits of the player. The player may also enter a ticket into the bill/ticket inlet 5B. On the surface of the ticket, the amount of the player's credits is printed with numbers and a bar code. The amount of the credits is decoded by a ticket reader installed in the bill/ticket inlet 5B from the bar code printed on the ticket, and then the amount of the credits is displayed on the middle display window 3B. If the player is allowed to use the credits stored in the server complex 60, the amount of the stored credits may be added to the amount of the coins and bills and the amount of the credits read from the ticket.

The player operates the gaming machine 10 by using the buttons 7. For example, by using one or more buttons 7, the player selects one or more winning lines of the symbol matrix displayed on the middle display window 3B, and then the selected winning line will be shown in the middle display window 3B. The player enters a bet into the gaming machine 10, and then the amount of the bet is displayed on the middle display window 3B. The player will push a spin button, and then the symbols displayed on the middle display window 3B will start moving in the vertical direction. After that, the player pushes stop buttons, and then the symbols stop column by column. When the selected winning line of the stopped symbol matrix includes a winning combination, the player will win an award based upon the bet and the probability of the winning combination. If the player pushes a payout button, then the coins equivalent to the player's credits are discharged out of the coin outlet 8A from a coin hopper installed in the cabinet 1 and stored in the coin receiver 8B. Alternatively, a ticket will come out of the ticket outlet 6. On the ticket, the amount of the player's credits is printed with numbers and a bar code by a ticket printer installed in the ticket outlet 6. At the time of the payout, the player can also use the buttons 7 to select either coins or a ticket. Note that, when the player's credits have been stored in the server complex 60, the amount of the credits is constantly updated in accordance with game results.

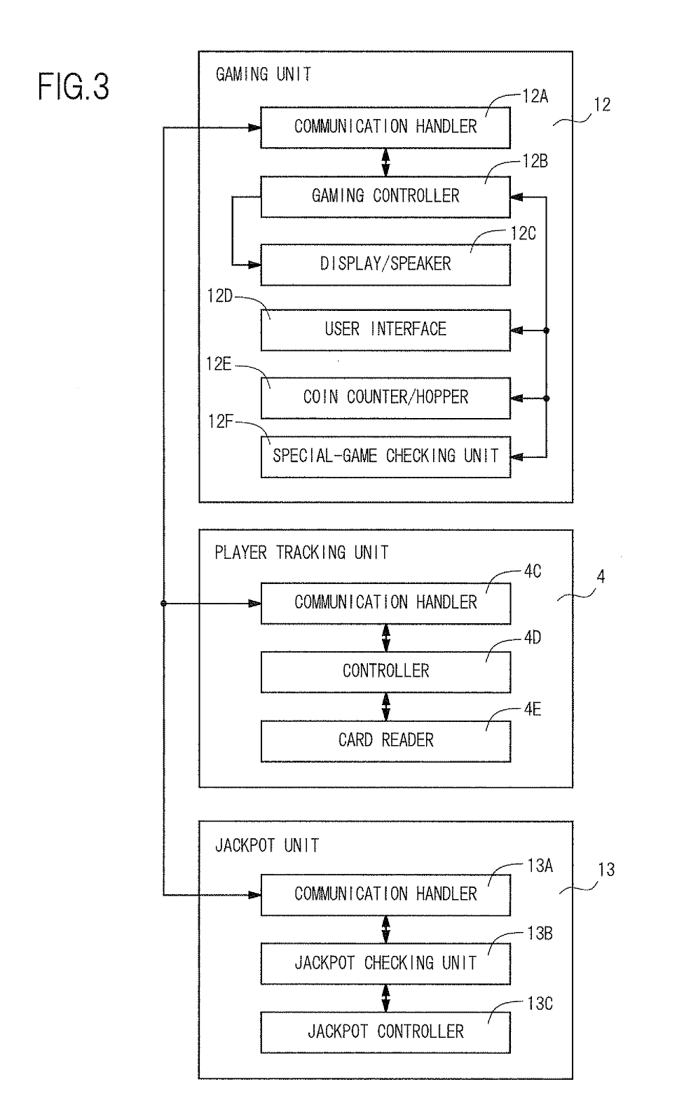

Preferably as shown in FIG. 3, the configuration of the gaming machine 10 is mainly divided into a gaming unit 12, the player tracking unit 4, and a jackpot unit 13. The three units 12, 4, and 13 include a communication handler 12A, 4C, and 13A, respectively, and thereby communicate with each other and the LAN 20.

The gaming unit 12 provides gaming functions and visual/sound effects by using control over devices installed in the cabinet 1. As shown in FIG. 3, the gaming unit 12 includes a gaming controller 12B, display/speaker drivers 12C, a user interface 12D, and a coin counter and a coin hopper 12E. The gaming controller 12B runs various programs and thereby controls other components of the gaming unit 12. In particular, the gaming controller 12B generates and uses one or more random numbers in a lottery process of each game. Depending on the random number(s), for example, an arrangement of the stopped symbols that are displayed in the middle display window 3B can include a winning combination. In addition, by using the display/speaker drivers 12C, the gaming controller 12B controls the images appearing in the three display windows 3A, 3B, 3C, and the sounds that come out of the speaker 9 (cf. FIG. 2). In particular, the gaming controller 12B will query the jackpot unit 13 about the jackpot values, and thereby display the jackpot values in the upper display window 3A. The user interface 12D relays various instructions from the buttons 7 to the gaming controller 12B. The gaming controller 12B updates the amount of the player's credits, in accordance with the amount of money inserted into the coin inlet 5A and the bill/ticket inlet 5B and counted by the coin counter 12E, and the amount that the ticket reader decodes from the ticket inserted in the bill/ticket inlet 5B. The gaming controller 12B also performs payout of the player's credits with coins discharged from the coin hopper 12E, or by using a ticket on which the amount of the credits is printed by the ticket printer.

The gaming unit 12 of the gaming machine 10 further comprises a special-game checking unit 12F (cf. FIG. 3). The special-game checking unit 12F receives instructions from the server complex 60 through the communication handler 12A and the gaming controller 12B, and according to the instructions, decides whether or not to allow the player to play a special game (described later in detail). Here, the special game is a game that a typical player will want to play, preferably a game with a higher payback percentage or a larger jackpot value.

The player tracking unit 4 includes another controller 4D separated from the gaming controller 12B (cf. FIG. 3). The controller 4D runs programs and thereby controls other components of the player tracking unit 4. In particular, by using the card reader 4E, the controller 4D reads data (in particular, customer ID data and the number of points) from an ID card that a player inserts into the card slot 4B (cf. FIG. 2). The controller 4D also receives input from the touch screen 4A. The controller 4D then sends the received data to the server complex 60 through the communication handler 4C and the LAN 20. When the player finishes playing games on the gaming machine 10, the controller 4D preferably updates the points stored in the ID card based upon the money that the player has spent on the gaming machine 10, and informs the server complex 60 of the updated points.

The jackpot unit 13 includes a jackpot checking unit 13B and a jackpot controller 13C. The jackpot checking unit 13B monitors the player's betting through the communication handler 13A, and informs the jackpot controller 13C of each bet of the player. Each time the player places a bet, the jackpot controller 13C will perform a lottery process independent of the lottery processes of the gaming unit 12, thereby deciding whether or not the player will win a jackpot. Here, the jackpot controller 13C may be a progressive jackpot controller, that is, it may increment jackpot values by a percentage of every bet placed by the player until the player wins a jackpot. The jackpot checking unit 13B then accesses the jackpot controller 13C to check the latest jackpot values and whether or not the player has won a jackpot. If the jackpot controller 13C decides that the player has won the jackpot, the jackpot checking unit 13B instructs the gaming controller 12B to inform the player of the winning of the jackpot and then increase the player's credits by the jackpot value. If the jackpot controller 13C is progressive, it will further reset the jackpot values. Here, two or more of the gaming machines 10 may be linked to a common jackpot controller 13C. In that case, common jackpot values are displayed in the upper display windows 3A of all the linked gaming machines 10. Each time a player places a bet on one of the linked gaming machines 10, the jackpot controller 13C will perform a lottery process independent of any of the lottery processes of the linked gaming machines 10, thereby deciding whether or not one of the gaming machines 10 wins a jackpot. If the jackpot controller 13C is a progressive jackpot controller, it will increment jackpot values by a percentage of every bet placed by the players on the linked gaming machines 10 until one of the players wins a jackpot.

The mobile gaming terminals 40 and the server complex 60 constitute a server-based gaming system, that is, the mobile gaming terminals 40 are each configured to relay customer ID data from a player to the server complex 60, and then display game content in accordance with data sent from the server complex 60, and inform the server complex 60 of data that the player enters into the mobile gaming terminal 40. Each of the mobile gaming terminals 40 is preferably provided to one customer at the reception desk in the casino, the front desk of the hotel, or the like, in return for registration of one's personal information with the server complex 60. The customer can then play games (preferably, online slot and poker games) on the mobile gaming terminal 40 in any gaming-allowed area of the entertainment center, for example, while waiting for food ordered at a restaurant, or while waiting for one's partner to complete his or her shopping. In addition, under the control of the server complex 60, the mobile gaming terminals 40 provide the customers with various kinds of useful information about each area of the entertainment center; a map, details on services of the restaurants and shops, a list of shows at the theaters, and guidance on the gaming machines 10 in the casino. In particular, the mobile gaming terminals 40 enable the customers to navigate the various areas of the entertainment center.

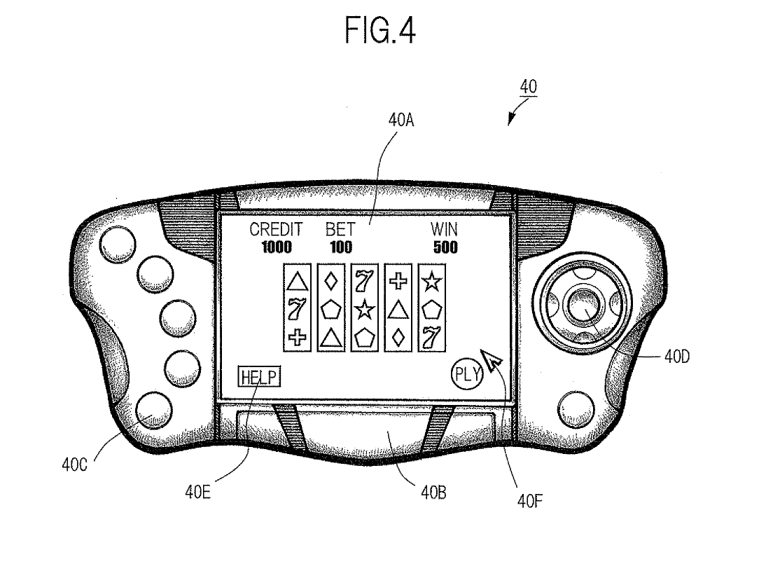

The mobile gaming terminal 40 is preferably a hand-held device as shown in FIG. 4. The mobile gaming terminal 40 comprises a display 40A, a card slot 40B, various buttons 40C, a cursor control button 40D, and a speaker built in the body (not shown in FIG. 4).

The display 40A reproduce various images: visual effects in games; visualized information on games such as pay tables and a guide to operations; game content such as three or more symbol columns, the amounts of player's credits, bet, and award; and a map and guide of each area in the entertainment center.

The card slot 40B allows a player who will start playing games on the mobile gaming terminal 40 to insert or pass one's ID card into or through the card slot 40B. A card reader installed in the card slot 40B reads the customer ID data and the stored points from the ID card, and sends the customer ID data to the server complex 60. The server complex 60 then authenticates the player based on the received customer ID data. In addition, the server complex 60 may require the player to enter additional personal information (preferably a password), and if the player enters the additional personal information that matches the registered personal information, the server complex 60 may allow the player to use his/her credits, which has been stored in the server complex 60 in advance, for playing games on the mobile gaming terminal 40.

If the authentication is successful, the server complex 60 allows the mobile gaming terminal 40 to be linked to one of the virtual gaming machines created in the server complex 60, and thus the player is allowed to start playing games on the mobile gaming terminal 40. In the case of an online slot game, for example, the mobile gaming terminal 40 displays a game window on the display 40A in accordance with data received from the virtual gaming machine linked to the mobile gaming terminal 40. The game window includes three or more symbol columns, numerals representing the amounts of player's credits, bet, and award, and various icons including button icons 40E. The player operates the mobile gaming terminal 40 by using the button icons 40E as well as the mechanical buttons 40C. Here, the button icons 40E are “pushed” (i.e. functions represented by the button icons 40E are performed) preferably by using a cursor 40F that the player moves in the game window with the cursor control button 40D, or the mechanical buttons 40C. Alternatively, the display 40A may be covered with a touch screen, and thereby, the button icons 40E may be “pushed” by the touch of a player's finger or a stylus. The data regarding the player's operations is sent to the virtual gaming machine. For example, the player will select one or more winning lines of the symbol matrix displayed on the display 40A, and then the selected winning line will be shown in the display 40A. The player will enter a bet, and then the amount of the bet will be displayed on the display 40A. The player will push a spin button, and then the symbols displayed on the display 40A start moving in the vertical direction. After that, the player will push one or more stop buttons, and then the symbols will stop column by column. When the selected winning line of the stopped symbol matrix includes a winning combination, the player will win an award based upon the bet and the probability of the winning combination. Note that the amount of the player's credits stored in the server complex 60 is constantly updated by the virtual gaming machine in accordance with game results. In addition, when the player finishes playing games, the virtual gaming machine will update the points stored in the ID card based on the money that the player has spent on the virtual gaming machine.

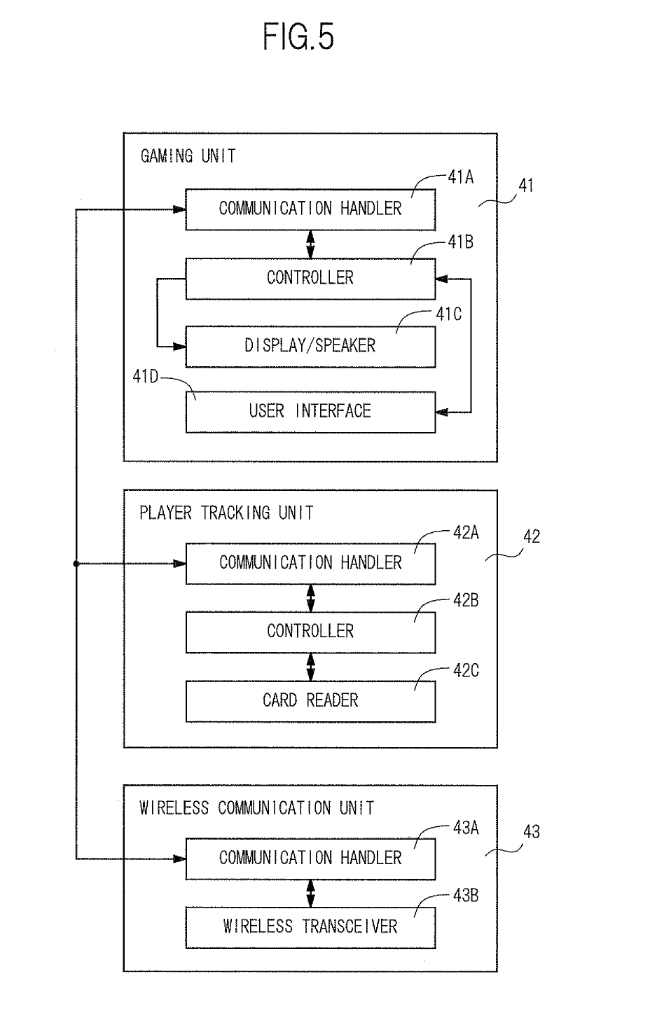

The configuration of the mobile gaming terminal 40 is mainly divided into three units; a gaming unit 41, a player tracking unit 42, and a wireless communication unit 43, as shown in FIG. 5. The three units 41, 42, and 43 include a communication handler 41A, 42A, and 43A, respectively, and thereby communicate with each other and, through the wireless communication unit 43, with the wireless LAN 50.

The gaming unit 41 displays game content (e.g. a matrix of symbols and the amounts of the player's credits, bet, and award), jackpot values, and reproduces visual/sound effects in accordance with data sent from the server complex 60. The gaming unit 41 also provides the server complex 60 with the data that the player inputs into the mobile gaming terminal 40. As shown in FIG. 5, the gaming unit 41 includes a controller 41B, display/speaker drivers 41C, and a user interface 41D. The controller 41B controls other components of the gaming unit 41 in accordance with instructions received from the server complex 60. In particular, by using the display/speaker drivers 41C, the controller 41B controls the images that will appear on the display 40A, and the sounds that will come out of the built-in speaker. The user interface 41D will control the button icons 40E and the cursor 40F in accordance with the player's operation of the cursor control button 40D, and thereby relay various instructions from the button icons 40E, as well as the mechanical buttons 40C, to the server complex 60 through the controller 41B and the wireless communication unit 43.

The player tracking unit 42 preferably includes another controller 42B separated from the above-mentioned controller 41B. Alternatively, the above-mentioned controller 41B may also serve as the controller 42B. The controller 42B runs programs and thereby controls other components of the player tracking unit 42. In particular, by using the card reader 42C, the controller 42B reads data (in particular, customer ID data and the number of points) from an ID card that a player inserts into or passes through the card slot 40B (cf. FIG. 4). The controller 42B also receives input from the user interface 41D. The controller 42B then sends the received data to the server complex 60 through the communication handler 42A and the wireless communication unit 43.

The wireless communication unit 43 includes a wireless transceiver 43B that preferably adheres to wireless LAN (IEEE 802.11x) standards. The wireless transceiver 43B can be wirelessly connected to one of the access points 30 (cf. FIG. 1), preferably register a type of terminal ID with the access point 30, and then allow data communications between the other components of the mobile gaming terminal 40 and the LAN 20 in any area of the entertainment center.

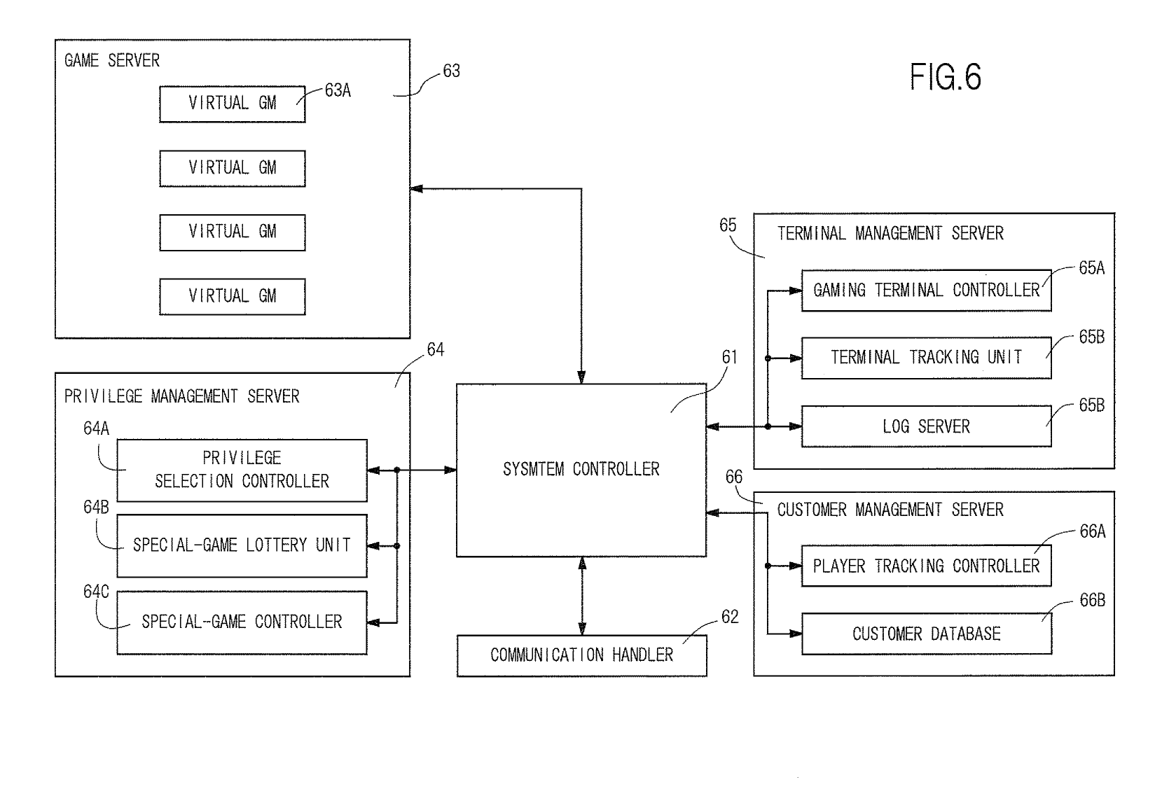

As shown in FIG. 6, the server complex 60 comprises a plurality of servers, which in particular include a game server 63, a privilege management server 64, a terminal management server 65, and a customer management server 66. The four servers 63, 64, 65, and 66 are integrally controlled by a system controller 61 and connected to the LAN 20 through a common communication handler 62.

The game server 63 is comprised of a plurality of virtual gaming machines (hereinafter, virtual GMs or VGMs) 63A, each of which can be linked to one of the mobile gaming terminals 40 by the terminal management server 65. Each virtual GM 63A runs a game program, and then sends game content to the linked mobile gaming terminal 40, and receives a player's response from the linked mobile gaming terminal 40. Here, two or more of the virtual GMs 63A may be linked to a single virtual jackpot controller, and thereby share common jackpot values.

The privilege management server 64 comprises a privilege selection controller 64A, a special-game lottery unit 64B, and a special-game controller 64C, which are interconnected and thereby communicate with each other.

The privilege selection controller 64A selects the types of privileges to be provided to the virtual GMs 63A, depending on the areas where the linked mobile gaming terminals 40 are located. Here, the privilege selection controller 64A receives, preferably from the terminal management server 65, data about the linkage between the virtual GMs 63A and the mobile gaming terminals 40. For example, when the mobile gaming terminals 40 are brought into the casino areas, the linked virtual GMs 63A may be allowed to offer players opportunities to play bonus games that preferably have higher payback percentages or larger jackpot values. When the mobile gaming terminals 40 are brought into the dining/shopping areas, the linked virtual GMs 63A may be allowed to offer players opportunities to receive discounts on food, goods, or services, and to increase their credits/points by a percentage of the amount paid for food or the like. When the mobile gaming terminals 40 are brought into the theater/hall areas, the linked virtual GMs 63A may be allowed to offer players opportunities to get discounts on tickets, or goods related to the entertainers performing therein. The privilege selection controller 64A may further select the types of privileges to be provided to the virtual GMs 63A, depending on the age, sex, status, or family structure of the players of the linked mobile gaming terminals 40. For example, when the mobile gaming terminals 40 are brought into the VIP areas and the players are actually VIPs, the linked virtual GMs 63A may be allowed to offer players special services for VIPs.

The special-game lottery unit 64B selects one of the mobile gaming terminals 40 under a lottery process, preferably regardless of whether or not linked to the virtual GMs 63A, and then stores customer ID data of a player who is playing (or is about to play) a game on the selected mobile gaming terminal 40. Here, the lottery process is preferably independent of the gaming processes of each of the virtual GMs 63A. Preferably by accessing the terminal management server 65 or the customer management server 66, the special-game lottery unit 64B will vary the lottery probabilities in accordance with the areas where each of the mobile gaming terminals 40 is detected, or by the customer information linked to customer ID data received from each of the mobile gaming terminals 40. The special-game lottery unit 64B will further provide the selected mobile gaming terminal 40 with an opportunity to play a special game in a specific area of the entertainment center. Here, the special game is a game that a typical player will want to play, preferably a game with a higher payback percentage or a larger jackpot value. The specific area is preferably the casino area or a section thereof. Preferably, the special-game lottery unit 64B also functions as a guidance unit configured to provide the selected mobile gaming terminal 40 with a map indicating one or more routes to a specific area of the entertainment center. Here, the specific area is preferably the casino area or a section thereof.

The special-game controller 64C checks customer ID data received from the mobile gaming terminals 40 brought into the above-mentioned specific area. If it detecting the same customer ID data as stored in the special-game lottery unit 64B, the special-game controller 64C will allow the player who has entered the detected customer ID data to play the above-mentioned special game on the mobile gaming terminal 40 brought into the specific area, that is, the special-game controller 64C will allow the virtual GM 63A linked to the mobile gaming terminal 40 to run the special game program. The special-game controller 64C may also check the customer ID data entered in the real gaming machines 10 (cf. FIG. 1) installed in the specific area, and if it detects the same customer ID data as stored in the special-game lottery unit 64B, it will allow the player who enters the detected customer ID data to play the special game on the gaming machine 10.

The terminal management server 65 comprises a gaming terminal controller 65A, a terminal tracking unit 65B, and a log server 65C, which are interconnected and thereby communicate with each other. The gaming terminal controller 65A manages the linkage between the virtual GMs 63A and the mobile gaming terminals 40, and in particular, establishes or terminates the connection therebetween. The terminal tracking unit 65B detects the area in which each of the mobile gaming terminals 40 is located, and in particular detects the mobile gaming terminals 40 brought into the specific area. Preferably, the terminal tracking unit 65B monitors the terminal IDs registered with each of the access points 30, and constantly updates a list of the mobile gaming terminals 40 connected to each of the access points 30, that is, the mobile gaming terminals 40 brought into the area where the access points 30 are located. The log server 65C stores a table showing the linkage between the virtual GMs 63A and the mobile gaming terminals 40, and the list of the mobile gaming terminals 40 brought into each area in the entertainment center.

The customer management server 66 comprises a player tracking controller 66A and a customer database 66B, which are interconnected and thereby communicate with each other. The player tracking controller 66A receives customer ID data and additional personal information from one of the gaming machines 10 or the mobile gaming terminals 40 through the LAN 20, and then verifies the received data against authorized customer ID data and personal information stored in the customer database 66B, thereby authenticating the player of the gaming machines 10 or the mobile gaming terminal 40. In addition, the player tracking controller 66A may update the player's credits and points stored in the customer database 66B, based upon the data received from the gaming machine 10 or the mobile gaming terminal 40. The customer database 66B stores personal information and credits of the registered customers. In the customer database 66B, the registered personal information and credits is linked to specific customer ID data.

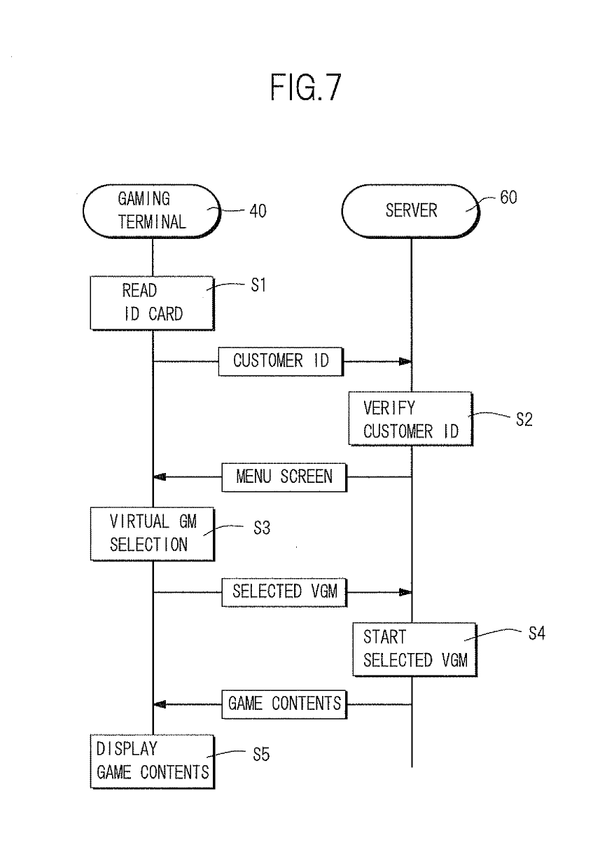

Each of the mobile gaming terminals 40 and the server complex 60 collaborate with each other according to a flow chart shown in FIG. 7, and thereby allow a player to select an available virtual GM 63A and to start playing a game in the following steps.

STEP S1: A player who wants to play a game on a mobile gaming terminal 40 first inserts or passes one's ID card into or through the card slot 40B of the mobile gaming terminal 40 (cf. FIG. 4). By using the card reader 42C installed in the card slot 40B, the player tracking unit 42 reads the customer ID data from the ID card inserted or passed into the card slot 40B, and then sends the read customer ID data to the customer management server 66. Here, additional personal information (e.g. a password) may be entered by using either the mechanical buttons 40C and/or the cursor control button 40D. The player tracking unit 42 sends the additional personal information, as well as the read customer ID data, from the user interface 41D to the server complex 60.

STEP S2: The customer management server 66 verifies the received customer ID data and additional personal information. If the verification is successful, the customer management server 66 allows the terminal management server 65 to send the list of available VGMs 63A to the mobile gaming terminal 40, preferably in a menu-screen form.

STEP S3: The mobile gaming terminal 40 displays the received menu screen, or the list of the available VGMs 63A, on the display 40A. The terminal management server 65 then instructs the mobile gaming terminal 40 to allow the player to select one of the displayed available VGMs 63A. The mobile gaming terminal 40 detects the selected VGM 63A through the user interface 41D, and informs the terminal management server 65 of the selected VGM 63A.

STEP S4: The terminal management server 65 links the selected VGM 63A to the mobile gaming terminal 40. The selected VGM 63A then starts executing a game program, and sends game content to the linked mobile gaming terminal 40.

STEP S5: The mobile gaming terminal 40 then displays the received game content, and reproduces visual/sound effects according to data sent from the linked VGM 63A. The mobile gaming terminal 40 also provides the linked VGM 63A with data that the player has entered into the mobile gaming terminal 40 through the user interface 41D.

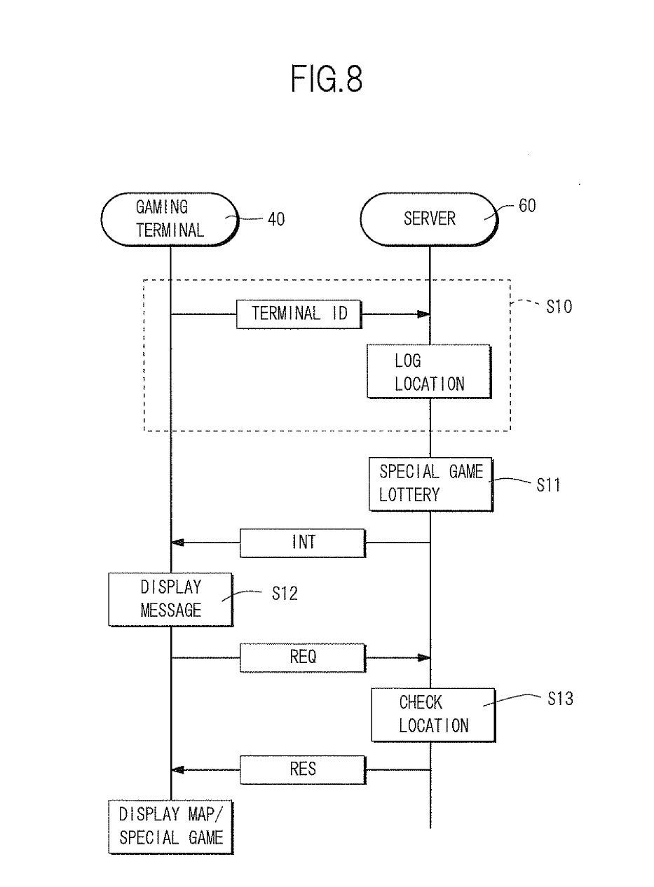

According to the flow chart shown in FIG. 8, the server complex 60 selects one of the mobile gaming terminals 40 at random, and invites the player to the specific area for the special game in the following steps.

STEP S10: Each of the mobile gaming terminals 40 registers its terminal ID with one of the access points 30. The terminal tracking unit 65B of the terminal management server 65 monitors the terminal IDs registered with each of the access points 30, and constantly updates the list of the mobile gaming terminals 40 brought into the area where the access point 30 is located.

STEP S11: The special-game lottery unit 64B performs the above-mentioned lottery process preferably at fixed time intervals, and then selects one of the mobile gaming terminals 40 at random, and stores the customer ID data of a player who is (or is about to start) playing a game on the selected mobile gaming terminal 40.

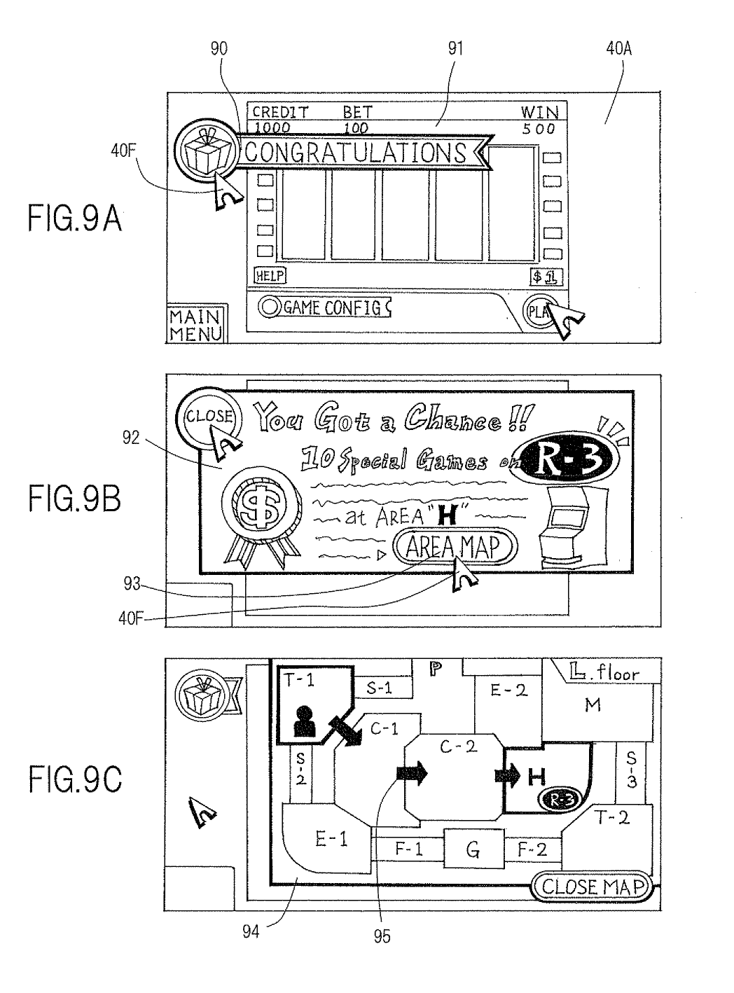

STEP S12: While the selected mobile gaming terminal 40 is linked to one of the VGM 64A, the special-game lottery unit 64B sends an interrupt request to the linked VGM 64A or the selected mobile gaming terminal 40. As shown in FIG. 9A, the interrupt request causes a banner icon 90 to appear and overlap the game window 91 on the display 40A of the selected mobile gaming terminal 40. The player will move the cursor 40F onto the banner icon 90, and push the cursor control button 40D. Then, as shown in FIG. 9B, a message window 92 will open on the display 40A, and inform the player that he or she has been provided with, for example, an opportunity to play the special game ten times in a specific area “H” of the entertainment center.

STEP S13: The player will move the cursor 40F onto an icon 93, and push the cursor control button 40D. Then, the user interface 41D will send a request to the privilege management server 64 through the linked VGM 63A or directly. Upon receipt of the request, the special-game controller 64C will first access the terminal management server 65 and thereby locate the area where the mobile gaming terminal 40 is located. If the mobile gaming terminal 40 is located in the specific area “H”, the special-game controller 64C next checks the customer ID data received from the mobile gaming terminals 40. When detecting the same customer ID data as stored in the special-game lottery unit 64B, the special-game controller 64C may allow the VGM 63A linked to the mobile gaming terminal 40 to promptly run the special game program. If the mobile gaming terminal 40 is not located in the specific area “H”, the special-game lottery unit 64B next returns a response, which includes a map indicating the specific area “H”, to the VGM 63A or the linked mobile gaming terminal 40. As shown in FIG. 9C, the map 94 then appears on the display 40A of the mobile gaming terminal 40, and in particular, a route to the specific area “H” is represented by a series of arrows 95, for example.

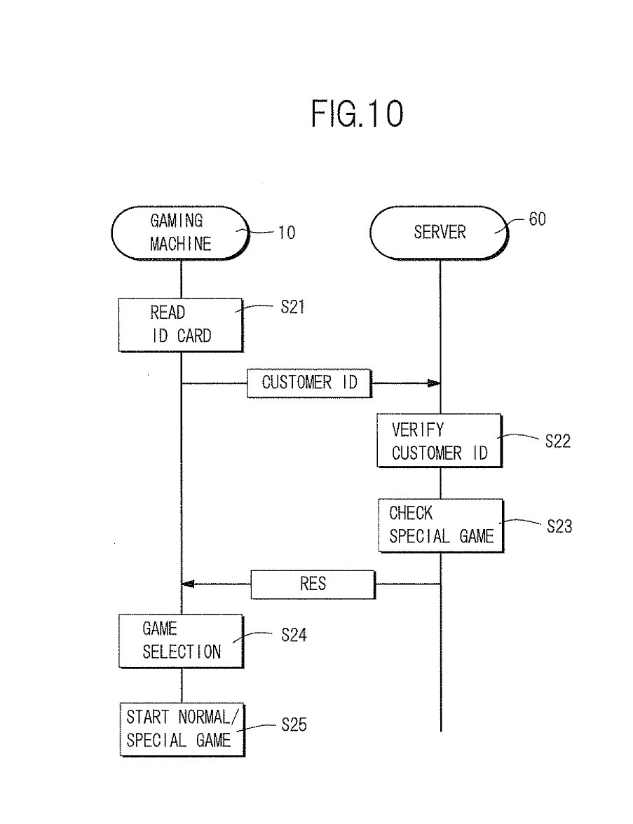

According to the flow chart shown in FIG. 10, the server complex 60 may allow a player of the selected mobile gaming terminal 40 to play the special game on a gaming machine 10 installed in the specific area in the following steps.

STEP S21: The player who wants to play a game on the gaming machine 10 will first insert his or her ID card into the card slot 4B (cf. FIG. 2). By using the card reader 4E installed in the card slot 4B, the player tracking unit 4 will read the customer ID data from the ID card inserted into the card slot 4B, and then send the customer ID data read therefrom to the customer management server 66. Here, additional personal information (e.g. a password) may be entered by using touch screen 4A and sent to the server complex 60 by the player tracking unit 4.

STEP S22: The customer management server 66 will verify the received customer ID data and the additional personal information. If the verification is successful, the customer management server 66 will request the special-game controller 64C to check the customer ID data received from the gaming machine 10, since the gaming machine 10 is located in the specific area.

STEP S23: If the special-game controller 64C detects that the received customer ID data matches the customer ID data stored in the special-game lottery unit 64B, the special-game controller 64C will send a response to the gaming machine 10.

STEP S24: After receiving the response, the gaming machine 10 will allow the player to decide between a normal game and the special game.

STEP S25: The gaming controller 12B will detect which game the player selects through the user interface 12D, and then start executing the game program that the player has selected.

The gaming system according to the above-described embodiment of the present invention selects one of the mobile gaming terminals 40 at random, and allows the customer in possession of the selected mobile gaming terminal 40 to play the special game when the customer brings one's mobile gaming terminal 40 into the specific area, or when the customer stays in the specific area. Accordingly, it can be expected that the customers will go to and stay in the specific area, and therefore that the number of customers will increase in the specific area. When the specific area is assigned to the casino or a section thereof, it can be expected that the number of customers playing games on gaming machines fixed in the casino will increase, and therefore the profitability of the casino will improve.

Preferably, the terminal tracking unit 65B detects the area in which each of the mobile gaming terminals 40 is located, and the special-game lottery unit 64B will vary the lottery probabilities with the detected areas. The variation in lottery probabilities can control the number of customers to go to or stay in the specific area. When the lottery probability is lower in the specific area compared to other areas, the number of customers who only stay in areas other than the specific area may decrease. When the lottery probability is higher in the specific area compared to other areas, the number of customers who go to and stay in the specific area may increase. In addition, the special-game lottery unit 64B may access the customer database 66B, and thereby vary the lottery probabilities based upon the customer information linked to the customer ID data received from each of the mobile gaming terminals 40. The variation in the lottery probabilities can control the type of players in the specific area. For example, when the lottery probability is higher for players with a higher number of credits stored in the server, the number of such players may increase in the specific area.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A gaming system arranged in a location, comprising:
a plurality of mobile gaming terminals and a server that are wirelessly interconnected with each other,
wherein:
each of the plurality of mobile gaming terminals is configured to send customer ID data from each player in possession of one of the plurality of mobile gaming terminals to the server, display game content in accordance with data received from the server, and provide the server with data input by each player into the plurality of mobile gaming terminals; and
the server comprises
a plurality of virtual gaming machines each configured to execute a game program, send game content to each of the plurality of mobile gaming terminals respectively linked to one of the plurality of virtual gaming machines, and receive player responses to the game content from the plurality of mobile gaming terminals,
a special-game lottery unit configured to select one of the plurality of mobile gaming terminals in a lottery process, store customer ID data that the selected mobile gaming terminal has sent to the server, and inform the selected mobile gaming terminal that the player in possession of the selected mobile gaming terminal is provided with an opportunity to play a special game in a specific area of the location,
a terminal tracking unit configured to detect whether one or more of the plurality of mobile gaming terminals has been brought into the specific area, and
a special-game controller configured to check customer ID data sent from a mobile gaming terminal detected by the terminal tracking unit in the specific area to the server, and allow the player in possession of the mobile gaming terminal detected in the specific area to play a special game on the mobile gaming terminal if the customer ID data received therefrom is the same as the customer ID data stored in the special-game lottery unit.

2. A gaming system according to claim 1, wherein
the terminal tracking unit is configured to detect the area of the location in which each of the plurality of mobile gaming terminals is located, and
the special-game lottery unit is configured to vary the lottery probability for each of the plurality of mobile gaming terminals based upon the area in which each of the plurality of mobile gaming terminals is located.

3. A gaming system according to claim 1, wherein
the server further comprises a customer management unit comprising:
a player tracking controller configured to authenticate the identity of a player in possession of one of the plurality of mobile gaming terminals based upon customer ID data received from the mobile gaming terminal, and
a customer database configured to store customer information linked to customer ID data; and
wherein the special-game lottery unit is configured to vary the lottery probability based upon the customer information linked to the customer ID data received from each of the plurality of mobile gaming terminals.

4. A gaming system according to claim 1, wherein
the terminal tracking unit is configured to detect the area of the location in which each of the plurality of mobile gaming terminals is located, and
the server further comprises a guidance unit configured to provide the player in possession of the mobile gaming terminal selected by the special-game lottery unit with a map indicating the specific area.

5. A gaming system arranged in a location, comprising:
a plurality of gaming machines installed in the location, a server that is connected to the gaming machines, and a plurality of mobile gaming terminals that are wirelessly connected to the server,
wherein:
each of the plurality of gaming machines is configured to send customer ID data from a player to the server, and allow each player to play a game on one of the plurality of gaming machines in accordance with an instruction from the server,
each of the plurality of mobile gaming terminals is configured to send customer ID data from each player in possession of one of the plurality of mobile gaming terminals to the server, display game content in accordance with data received from the server, and provide the server with data input by each player into the plurality of the mobile gaming terminals; and
the server comprising:
a plurality of virtual gaming machines each configured to execute a game program, send game content to each of the plurality of the mobile gaming terminals respectively linked to one of the plurality of virtual gaming machines, and receive player responses to the game content from the plurality of mobile gaming terminals,
a special-game lottery unit configured to select one of the plurality of mobile gaming terminals in a lottery process, store customer ID data that the selected mobile gaming terminal has sent to the server, and inform the selected mobile gaming terminal that the player in possession of the selected mobile gaming terminal is provided with an opportunity to play a special game on one of the plurality of gaming machines installed in a specific area of the location, and
a special-game controller configured to check customer ID data sent by a player from the gaming machine installed in the specific area, and allow the player who has entered the customer ID data to play a special game on the gaming machine installed in the specific area if the customer ID data received therefrom is the same as the customer ID data stored in the special-game lottery unit.

6. A gaming system according to claim 5, wherein
the server further comprises a terminal tracking unit configured to detect the area of the location in which each of the plurality of mobile gaming terminals is located, and
the special-game lottery unit is configured to vary the lottery probability for each of the plurality of mobile gaming terminals based upon the area in which each of the plurality of mobile gaming terminals is located.

7. A gaming system according to claim 5, wherein
the server further comprises a customer management unit comprising:
a player tracking controller configured to authenticate the identity of a player in possession of one of the plurality of mobile gaming terminals based upon customer ID data received from the mobile gaming terminal, and
a customer database configured to store customer information linked to customer ID data; and
wherein the special-game lottery unit is configured to vary the lottery probability based upon the customer information linked to the customer ID data received from each of the plurality of mobile gaming terminals.

8. A gaming system according to claim 5, wherein the server further comprises:
a terminal tracking unit configured to detect the area of the location in which each of the plurality of mobile gaming terminals is located, and
a guidance unit configured to provide the player in possession of the mobile gaming terminal selected by the special-game lottery unit with a map indicating the specific area.
